(19) United States
(12) Patent Application Publication
(10) Pub. No.: US 2010/0165903 A1
(43) Pub. Date: Jul. 1, 2010

(54) Radio Communication Terminal and Communication Method

(75) Inventor: Hirohiko Inohiza, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/158,656

(22) PCT Filed: Dec. 21, 2006
(86) PCT No.: PCT/JP2006/325552

§ 371 Date: Jan. 19, 2010

(30) Foreign Application Priority Data
Dec. 22, 2005 (JP) 2005-370173

(51) Int. Cl. H04H 20/71

(52) U.S. Cl. 370/312

(57) ABSTRACT

A radio communication terminal of the present invention determines expected communication speeds used on a forward link on the basis of receiving conditions of carriers Cfw1 to Cfw3 and transmits DRC values indicating the expected communication speeds to radio base stations. When the number of reverse link carriers used for communication on a reverse link is less than the number of radio base stations, the radio communication terminal transmits the speed control values for the radio base is stations by use of a carrier Crv1.

### TECHNICAL FIELD

The present invention relates to a communication control system, a radio communication terminal and a communication control method that are applied to communications by a multicarrier using a plurality of carriers.

### BACKGROUND ART

In a mobile communication system using code division multiple access (CDMA), 1×EV-DO (1×evolution-data only) achieving high speed data communications is provided (Japanese Patent Application Publication No. 2002-300644 (pages 2-3 and FIG. 1), for example).

In 1×EV-DO, a single carrier is assigned to a single user (radio communication terminal). Furthermore, the implementation of a so-called “multicarrier” has been in consideration, the multicarrier achieving even higher speed data communications by assigning a plurality of carriers (three carriers, for example) to a single user.

In 1×EV-DO and n×EV-DO, an “expected communication speed” to be used on a forward link (a direction from a radio base station to a radio communication terminal) is determined on the basis of a receiving condition of a carrier at a radio communication terminal.

The radio communication terminal periodically transmits a speed control value to each base station using a carrier on a reverse link (a direction from the radio communication terminal to the radio base station) set between the radio communication terminal and the radio base station. The speed control value indicates the expected communication speed and is, specifically, a DRC (date rate control) value (referred to, hereinafter, as “DRC value”).

### DISCLOSURE OF INVENTION

In n×EV-DO, due to a difference between communication speeds on the forward link and the reverse link, and the like, the number of reverse link carriers may be less than the number of radio base stations transmitting forward link carriers.

In this case, a problem occurs in that the radio communication terminal cannot transmit the speed control value (DRC value) to each radio base station by use of the reverse link carriers.

Therefore, the present invention has been made in light of the above-described issues. An object of the present invention is to provide a radio communication terminal and a communication method in which, even when the number of reverse link carriers is less than the number of radio base stations transmitting forward link carriers, the radio communication terminal can notify the radio base stations of speed control values with certainty.

To solve the above-described issues, the present invention has the following aspects. To being with, a first aspect of the present invention is summarized as a radio communication terminal (radio communication terminal 200) configured to communicate with a plurality of radio base stations (radio base stations 100A to 100C) by a multicarrier using a plurality of carriers, comprising: an expected communication speed determination unit (DRC processor 210) is configured to determine expected communication speed to be used on a forward link on the basis of receiving condition of the carriers; and a speed control value transmitter (radio transmission and reception unit 201 and signal processor 203) configured to transmit a speed control value (DRC value) indicating the expected communication speed determined by the expected communication speed determination unit, to the radio base stations, wherein when the number of reverse link carriers used for communication on a reverse link (for example, one carrier) is less than the number of forward link radio base stations transmitting a forward link carrier used for communication on the forward link (for example, three stations), the speed control value transmitter transmits the speed control value for the respective forward link radio base stations by use of any of the reverse link carriers.

In a radio communication terminal such as that described above, when the number of reverse link carriers is less than the number of forward link base stations transmitting the forward link carriers, the speed control value for each radio base station is transmitted using any of the reverse link carriers.

The speed control value that is for each forward link radio base station and that is transmitted to either of the forward link radio base stations is relayed to the radio base station using an existing communication protocol.

Therefore, even when the number of reverse link carriers is less than the number of forward link radio base stations, the radio base station can be notified of the speed control value with certainty.

A second aspect of the present invention is summarized as the radio communication terminal according to the first aspect of the invention. The radio communication terminal further comprises a time frame extension unit (signal processor 203) configured to extend a time frame used to transmit the speed control value, wherein the speed control value transmitter transmits the speed control value for the forward link radio base stations by use of the time frame extended by the time frame extension unit.

A third aspect of the present invention is summarized as the radio communication terminal according to the first aspect of the invention. The radio communication terminal further comprises a receiver (radio transmission and reception unit 201 and signal processor 203) configured to receive timing of transmission of the speed control value for the radio base stations, from the radio base stations, wherein the speed control value transmitter transmits the speed control value for the radio base stations on the basis of the timing received by the receiver.

A fourth aspect of the present invention is summarized as the radio communication terminal according to the first aspect of the invention. In the radio communication terminal, different spreading codes (for example, Walsh code) are used for respective channels, in the reverse link, carriers, the radio communication terminal further comprising a code number increasing unit (Walsh code processor 217) configured to increase the number of the spreading codes, wherein the speed control value transmitter transmits the speed control value for the forward link radio base stations using a new channel generated on the basis of the spreading codes increased by the code number increasing unit.

A fifth aspect of the present invention is summarized as the radio communication terminal according to the first aspect of the invention. In the radio communication terminal, error tolerance improvement information (bi-orthogonal encoding and codeword repetition) improving tolerance against a transmission error is added to the speed control value, and the speed control value transmitter omits addition of the error tolerance improvement information, and transmits the speed control value for the forward link radio base stations instead of the error tolerance improvement information.

A sixth aspect of the present invention is summarized as a communication method for performing communication between a plurality of radio base stations and a radio communication terminal by a multicarrier using a plurality of carriers, comprising the steps of: determining (Steps S35 and 55) expected communication speed to be used on a forward link on the basis of receiving condition of the respective carriers; and transmitting (Steps S40 and 60) a speed control value indicating the determined expected communication speed to the respective radio base stations, wherein when the number of reverse link carriers used for communication on a reverse link is less than the number of forward link radio base stations transmitting a forward link carrier used for communication on the forward link, the speed control value for the forward link radio base stations is transmitted using any of the reverse link carriers, in the step of transmitting.

A seventh aspect of the present invention is summarized as the communication method according to the sixth aspect of the invention. The communication method further comprises a step of extending a time frame used to transmit the speed control value. At the step of transmitting, the speed control value for the forward link radio base stations is transmitted using the extended time frame.

An eighth aspect of the present invention is summarized to as the communication method according to the sixth aspect of the invention. The communication method further comprises a step of receiving (Steps S120 and 170) timing of transmission of the speed control value for the radio base stations, from the radio base stations, wherein in the step of transmitting, the speed control value for the radio base stations is transmitted on the basis of the timing received in the step of receiving.

A ninth aspect of the present invention is summarized as the communication method according to the sixth aspect of the invention. In the communication method, different spreading codes are used for respective channels, in the reverse link carriers, the communication method further comprising a step of increasing the number of the spreading codes, wherein in the step of transmitting, the speed control value for the forward link radio base stations is transmitted using a new channel generated on the basis of the increased spreading codes.

A tenth aspect of the present invention is summarized as the communication method, according to the sixth aspect of the invention. In the communication method, error tolerance improvement information improving tolerance against a transmission error is added to the speed control value; and in the step of transmitting, addition of the error tolerance improvement information is omitted, and the speed control value for the forward link radio base stations is transmitted instead of the error tolerance improvement information.

The present invention provides a radio communication terminal and a communication method in which, even when the number of reverse link carriers is less than the number of radio base stations transmitting the forward link carriers, the radio is base stations can be notified of speed control values with certainty.

### BRIEF DESCRIPTION OF DRAWINGS

FIG. 1 is a schematic configuration diagram of a mobile communication network including a radio communication terminal according to first and second embodiments of the present invention.

FIG. 2 is a functional block configuration diagram of a radio base station according to the first and second embodiments of the present invention.

FIG. 3 is a functional block configuration diagram of the radio communication terminal according to the first and second embodiments of the present invention.

FIG. 4 is a schematic communication sequence diagram related to transmission of a DRC value according to the first embodiment of the present invention.

FIG. 5 is a detailed communication sequence diagram related to an extension of DRC Length according to the first embodiment of the present invention.

FIG. 6 is a diagram showing a configuration of a DRC channel according to the first embodiment of the present invention and a configuration of a conventional DRC channel.

FIG. 7 is a diagram showing definitions of fields in a TCA message according to the first embodiment of the present invention.

FIG. 8 is a diagram showing an example of a TCA message using Band Class according to the first embodiment of the present invention.

FIG. 9 is a detailed, diagram' of functional blocks implementing a function related to spreading code processing according to the second embodiment of the present invention.

FIG. 10 is a diagram showing combinations of Walsh codes according to the second embodiment of the present invention.

FIG. 11 is a reverse link channel configuration diagram according to the second embodiment of the present invention.

### BEST MODE FOR CARRYING OUT THE INVENTION

Next, an embodiment of the present invention will be described. Note that same or similar reference numerals are given to denote same or similar portions in the descriptions of the drawings, hereinafter. However, the drawings are only schematically shown, and proportions of sizes and the like are different from actual ones, however.

Accordingly, the specific sizes and the like should be judged by referring to the descriptions below. Furthermore, as a matter of course, there are included portions where relationships or proportions of sizes of the drawings are different with respect to one another.

### First Embodiment

### Schematic Configuration of Mobile Communication Network

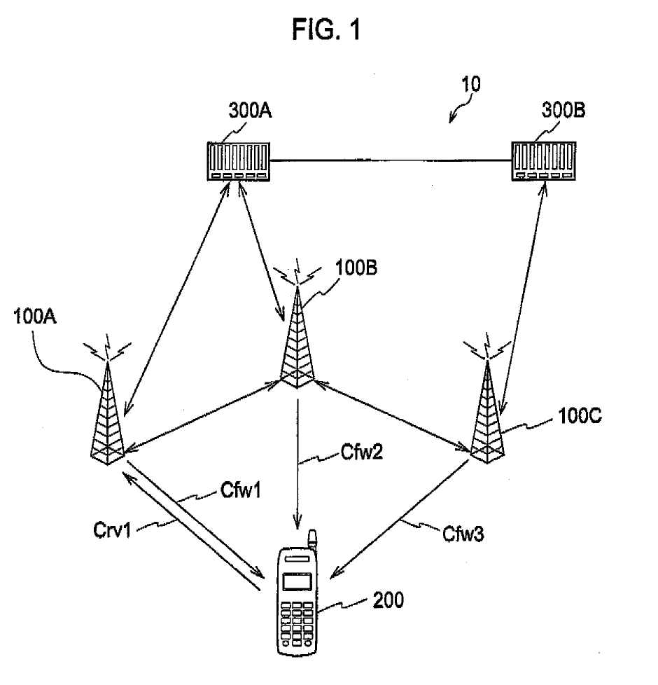

FIG. 1 is a schematic configuration diagram of a mobile communication network 10 including a radio communication terminal according to a first embodiment of the present invention.

The mobile communication network 10 provides high speed data communication (n×EV-DO) through a multicarrier using a plurality of carriers. The data communication includes voice data by VoIP.

A radio base station 100A is a radio base station (AN) that can transmit and receive at least one carrier. A radio base station 100B and a radio base station 100C also have configurations similar to that of the radio base station 100A.

A radio communication terminal 200 is a mobile phone terminal (access terminal [AT]) that can perform communication with the radio base stations 100A to 100C through a multicarrier using a plurality of carriers.

Packet control functions (PCF) 300A and 300B are connected to the radio base stations 100A to 100C, and control packet transmission paths and the like passing through the radio base stations 100a to 100C. The number of radio base stations, radio communication terminals, and PCF included in the mobile communication network 10, and the number of carriers a not limited to the numbers shown in FIG. 1.

In the mobile communication network 10, an “expected communication speed” to be used on a forward link (a direction from the radio base stations 100A to 100C to the radio communication terminal 200) is determined.

Specifically, the radio communication terminal 200 periodically transmits a DRC value (speed control value) to each radio communication terminal 100A to 100C, using a carrier on a reverse link (a direction from the radio communication terminal 200 to the radio base stations 100A to 100C) set between the radio communication terminal 200 and the base stations. The DRC value indicates the expected communication speed.

### (Functional Block Configuration)

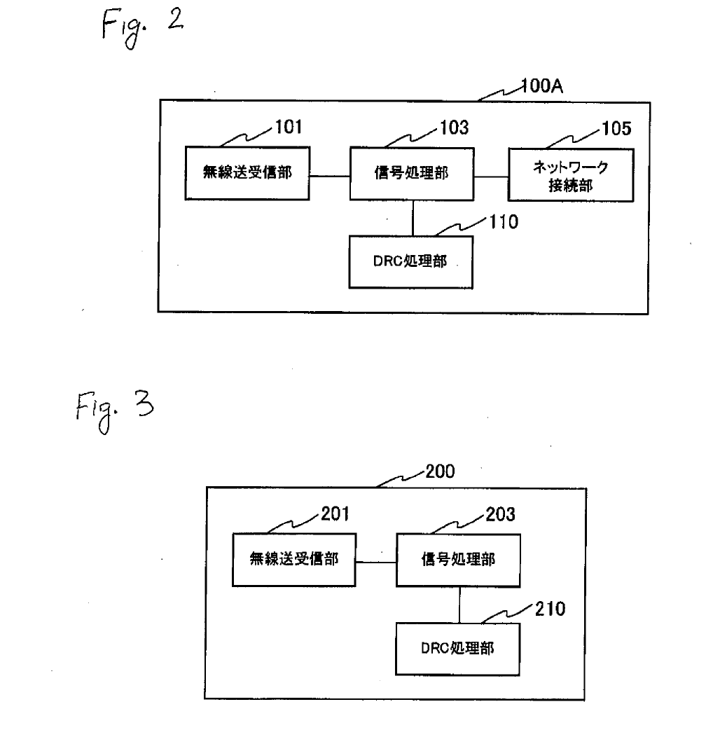

FIG. 2 is a functional block configuration diagram of the radio base station 100A. FIG. 3 is a functional block configuration diagram of the radio communication terminal 200.

Note that, hereinafter, descriptions will be mainly given of portions related to the present invention. Therefore, the radio base station 100A and the radio communication terminal 200 may include functional blocks (such as a power supply unit) that are required for causing the device to function but that are not shown or are omitted in the description.

### (1) Radio Base Station 100A

As shown in 2, the radio base station 100A includes a radio transmission and reception unit 101, a signal processor 103, a network connection unit 105, and a DRC processor 110.

The radio transmission and reception unit 101 transmits and receives a radio signal to and from the radio communication terminal 200. The radio signal is configured by a single carrier (carrier Cfw1: see FIG. 1). The radio transmission and reception unit 101 also performs a digital modulation (and demodulation) process on the radio signal and a base band signal. The radio transmission and reception unit 101 transmits and receives the base band signal to and from the signal processor 103.

The signal processor 103 processes the base band signal and relays the base band signal between the radio transmission and reception unit 101 and the network connection unit 105.

The signal processor 103 also relays the DRC value received from the radio communication terminal 200, via the radio transmission and reception unit 101, to the DRC processor 110.

The network connection unit 105 provides a network interface for connecting the PCF 300A with 300B.

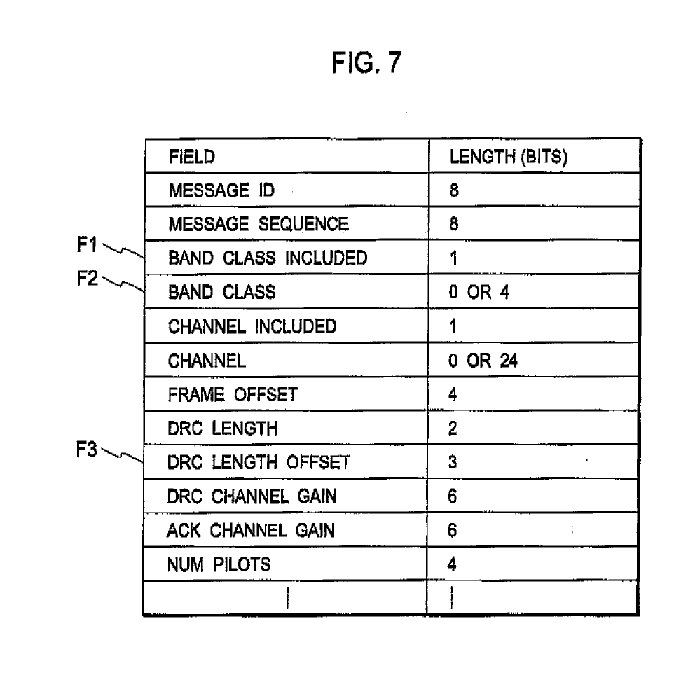

The DRC processor 110 controls a communication speed of data transmitted using a forward link carrier on the basis of the DRC value received from the radio communication terminal 200. As shown in FIG. 7, the DRC processor 110 can also store a table defining content of a TCA (traffic channel assignment) message.

The DRC processor 110 can instruct the radio communication terminal 200 about a timing of transmission of the DRC value. Specifically, the DRC processor 110 transmits information to the radio communication terminal 200, the information indicating the timing at which to transmit the DRC value.

### (2) Radio Communication Terminal 200

As shown in FIG. 3, the radio communication terminal 200 includes a radio transmission and reception unit 201, a signal processor 203, and a DRC processor 210.

The radio transmission and reception unit 201 can transmit and receive a radio signal to and from each radio base station 100A to 100C. The radio signal is configured by a single carrier. The radio transmission and reception unit 201 also performs a digital modulation (and demodulation) process on the radio signal and a base band signal. The radio transmission and reception unit 201 transmits and receives the base band signal to and from the signal processor 203.

The signal processor 203 processes the base band signal. The signal processor 203 also transmits the DRC value outputted by the DRC processor 210 to the radio base stations 100A to 100C. According to the embodiment, the radio transmission and reception unit 201 and the signal processor 203 configure a speed control value transmission unit.

According to the embodiment, when the number of reverse link carriers is less than the number (three stations) of radio base stations (forward link radio base stations) transmitting forward link carriers (carriers Cfw1 to Cfw3: see FIG. 1), the signal processor 203 uses any of the reverse link carriers and transmits the DRC value for each radio base station transmitting the forward link carriers.

For example, when the radio communication terminal 200 respectively receives a single carrier Cfw1 to Cfw3 from the radio base stations 100A to 100C on the forward link, the radio communication terminal 200 does not necessarily respectively transmit a single carrier to the radio base stations 100A to 100C on the reverse link.

In other words, because of a difference in communication speed between the forward link and the reverse link, transmission power saving, application characteristics, and the like, the radio communication terminal 200 may transmit a carrier Crv1 (see FIG. 1) to only the radio base station 100A on the reverse link.

In this case, the signal processor 203 transmits the DRC values for the radio base station 100B and the radio base station 100C using the carrier Crv1 transmitted to the radio base station 100A. The radio base station 100A that has received the DRC values for the radio base station 100B and the radio base station 100C respectively relays the DRC values to the radio base station 100B and the radio base station 100C.

The signal processor 203 can extend a time frame used to transmit the DRC values. According to the embodiment, the signal processor 203 configures a time frame extension unit.

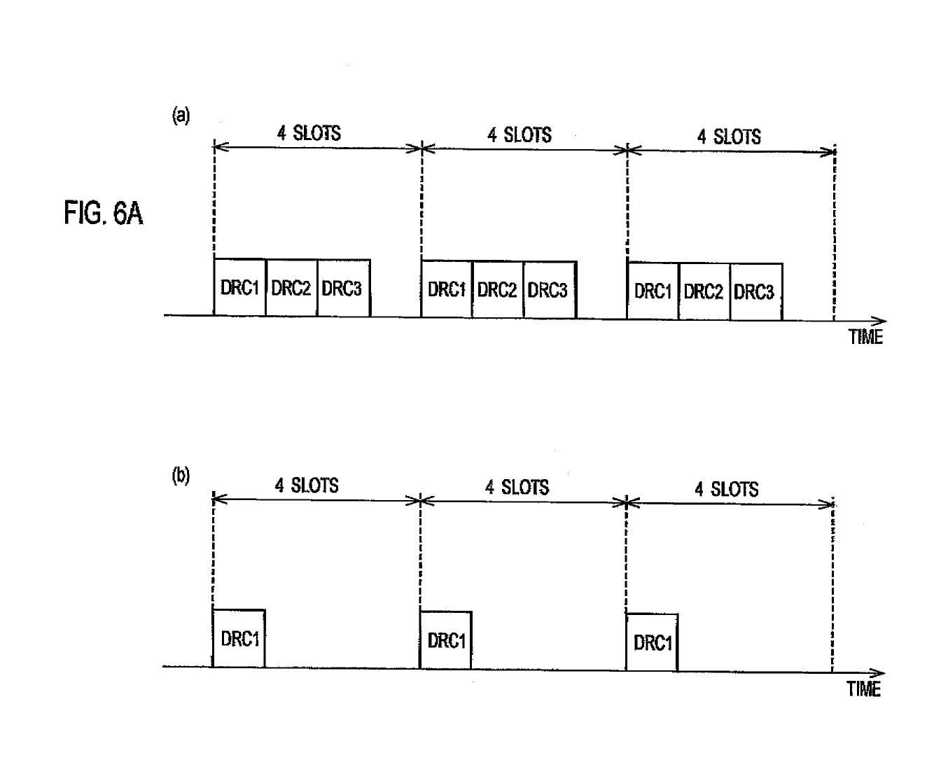

Specifically, as shown in FIG. 6(a), the signal processor 203 extends a DRC Length from one slot to four slots, the DRC Length being included in a DRC channel. FIG. 6(b) shows a configuration of a conventional DRC channel in which the DRC Length is not extended.

According to the embodiment, the signal processor 203 uses the four slots and transmits the DRC values for multiple to radio base stations using the carrier Crv1. For example, the DRC value for the radio base station 100A can be assigned to “DRC1” and the DRC value for the radio base station B can be assigned to “DRC2”.

According to the embodiment, a transmission timing at which the DRC value is transmitted front the radio communication terminal 200 to the radio base station 100A is determined between the radio communication terminal 200 and the radio base station 100A. Therefore, the content of a TCA (traffic channel assignment) message is expanded.

Specifically, as shown in FIG. 7, a field F1 (Band Class Included), a field F2 (Band Class), and a field F3 (DRC Length Offset) are added.

When the radio base station supports multiband in which multiple frequency bands are used, the field F1 (Band Class Included) is set to “1” and the field F2 (Band Class) becomes valid.

The field F2 (Band Class) indicates a Band Class in which the radio communication terminal 200 performs communication. The field F3 (DRC Length Offset) indicates the timing at which the DRC value is transmitted. A specific usage method of the fields will be described hereafter.

The signal processor 203 can receive the timing at which to transmit the DRC values for the radio base stations, from the radio base stations 100A to 100C. According to the embodiment, the radio transmission and reception unit 201 and the signal processor 203 configure a receiver.

The signal processor 203 can transmit the DRC value for each radio base station on the basis of the received timing.

The DRC processor 210, determines the expected communication speed to be used on the forward link on the basis of a receiving condition of the carrier received by the radio transmission and reception unit 201. According to the embodiment, the DRC processor 210 configures an expected communication speed determination unit.

The DRC processor 210 outputs the DRC value indicating the determined expected communication speed to the signal processor 203.

### (Operations of the Radio Communication Terminal and the Radio Base Station)

Next, operations of the radio communication terminal 200 and the radio base station 100A will be described. Specifically, an operation performed by the radio communication terminal 200 to transmit the DRC values for the radio base stations 100A to 1000 using the carrier Crv1 will be described.

### (1) Schematic Communication Sequence

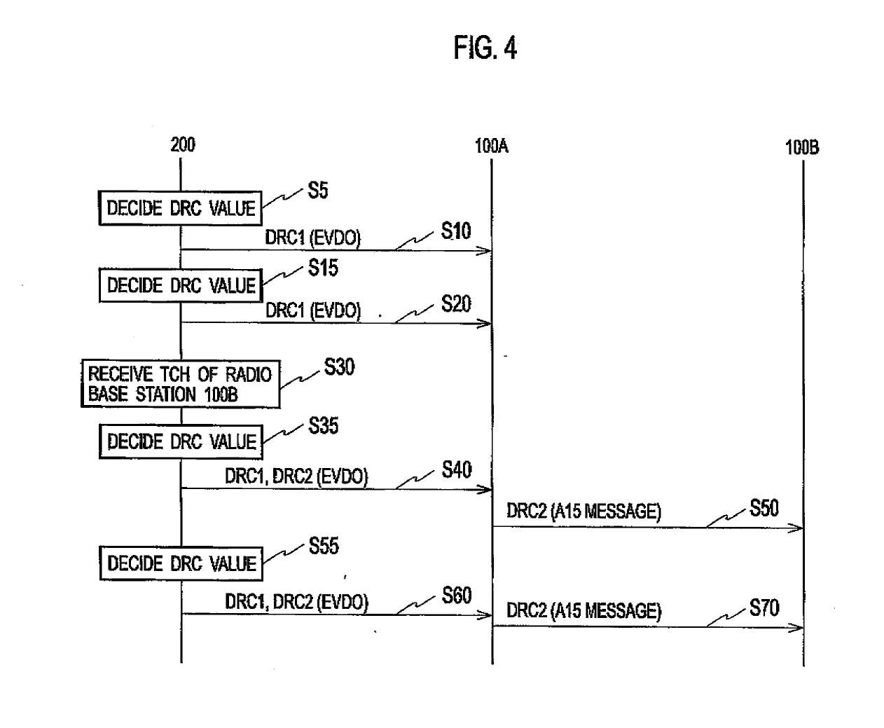

FIG. 4 is a schematic communication sequence diagram related to the transmission of the DRC value. As shown in FIG. 4, in step S5, the radio communication terminal 200 detects a communication speed of data transmitted by the carrier Cfw1 received from the radio base station 100A, and a receiving condition of the carrier (such as CIR). The radio communication terminal 200 also determines the expected communication speed (DRC values DRC 1 in the diagram) to be used for the data transmitted by the carrier Cfw1 on the basis of the detection results.

In step S10, the radio communication terminal 200 uses the carrier Cfw1 and transmits the DRC value (DRC 1) to the radio base station 100A.

In steps S15 and S20, the radio communication terminal 200 repeats the processing similar to the processings in steps S5 and S10.

In step S30, the radio communication terminal 200 receives a carrier Cfw2 transmitted from the radio base station 100B. Specifically, the radio transmission terminal 200 receives a T-CH (traffic channel).

In step S35, the radio communication terminal 200 detects the communication speed of data transmitted by the carrier Cfw1 and the carrier Cfw2 respectively received from the radio base station 100A and 100B, and the receiving condition of the carrier. The radio communication terminal 200 also determines the expected communication speed (DRC values: DRC 1 and DRC 2 in the diagram) to be used for the data transmitted by the carrier Cfw1 and the carrier Cfw2 on the basis of the detection results.

In step S40, the radio communication terminal 200 uses the carrier Cfw1 and transmits the DRC values (DRC 1 and DRC 2) to the radio base station 100A.

In step S50, the radio base station 100A relays the received DRC value (DRC 2) for the radio base station 100B to the radio base station 100B. When the DRC value for the radio base station 100C is included, the radio base station 100B can further relay the DRC value for the radio base station 100C. Alternatively, the radio base station 100A can transmit the DRC value to the radio base station 100C.

In step S60, the radio communication terminal 200 repeats a processing similar to that in step S40. In step S70, the radio base station 100A repeats a processing similar to that in step S50.

### (2) Detailed Sequence

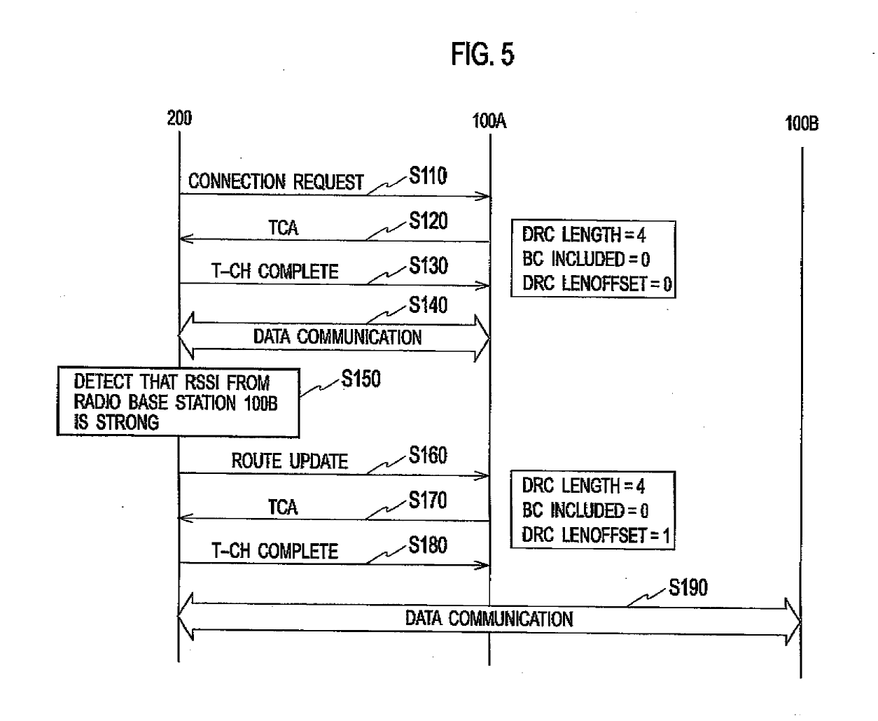

FIG. 5 is a detailed communication sequence related to DRC Length extension. As shown in FIG. 5, in step S110, the radio communication terminal 200 transmits a connection request to the radio base station 100A.

In step S120, the radio base station 100A transmits a TCA message to the radio communication terminal 200. Specifically, the radio base station 100A transmits a TCA message in which DRC Length=4, Sand Class Included=0, and DRC Length Offset=0 on the basis of the table shown in FIG. 7. In this case, the DRC value is transmitted at the timing of “DRC 1” shown in FIG. 6(a).

Each radio base station can transmit the timing at which to transmit the DRC value to the radio base station itself, to the radio communication terminal 200. The radio communication terminal 200 can transmit the DRC value for each radio base station on the basis of the received timings.

In step S130, the radio communication terminal 200 transmits a notification (T-CH Complete) to the radio base station 100A, the notification indicating that T-CH setting has been completed, on the basis of the received TCA message.

In step S140, the radio base station 100A and the radio communication terminal 200 starts data communication using the set T-CH.

In step S150, the radio communication terminal 200 detects that RSSI of the carrier Cfw2 transmitted from the radio base station 100B is strong.

In step S160, the radio communication terminal 200 uses the carrier Cfw2 and transmits a message (Route Update) to the radio base station 100A, the message indicating that forward link communication with the radio base station 100B has also started.

In step S170, the radio base station 100A transmits a TCA message to the radio communication terminal 200. Specifically, the radio base station 100A transmits a TCA message in which DRC Length=4, Band Class Included=0, and DRC Length Offset=1 on the basis of the table shown in FIG. 7. In this case, the DRC value is transmitted at the timing of “DRC 2” shown in FIG. 6(a).

In step S180, the radio communication terminal 200 transmits a notification (T-CH Complete) to the radio base station 100A, the notification indicating that T-CH setting has been completed, on the basis of the received TCA message.

In step S190, the radio base station 100B and the radio communication terminal 200 starts data communication using the set T-CH. The data communication started in step S140 is continued even in step S190.

### Modified Example

According to the above-described embodiment, Band Class is not used. However, a change can be made to transmit a TCA message using Band Class when multiple bands are used.

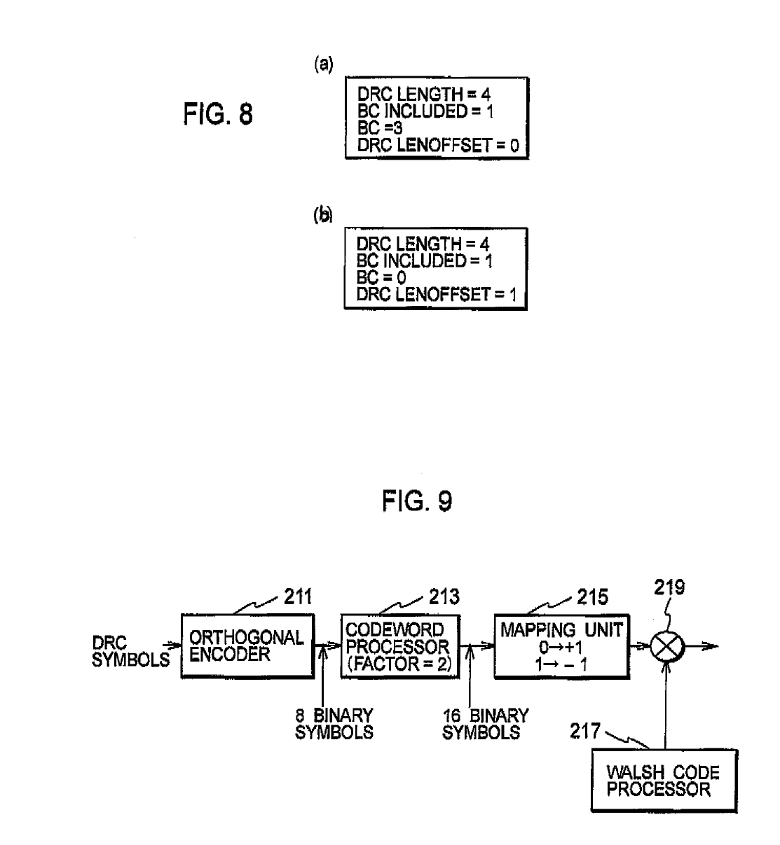

FIGS. 8(a) and (b) show an example of a TCA message using Band Class. Specifically, FIG. 8(a) shows a TCA message that can be transmitted in the above-described step S120.

When the TCA, message shown in FIG. 8(a) is compared with the TCA message shown in FIG. 5, the value of Band Class Included (BC included) is “1”. In other words, Band Class (BC) becomes valid. Band Class is set to “3”.

FIG. B (b) shows a TCA message that can be transmitted in the above-described step S170.

When the TCA message shown in FIG. 8(b) is compared to the TCA message shown in FIG. 5, the value of Band Class Included (BC included) is “1”. In other words, Band Class (BC) becomes valid. Band Class is set to “0”, indicating that communication with the radio base station 100B is required to be performed using a frequency band different from that for communication with the radio base station 100A.

### Second Embodiment

Next, a second embodiment of the present invention will be described. According to the embodiment, multiple DRC values are transmitted through use of the carrier Crv1. Therefore, the number of spreading codes (Walsh code) applied to the carrier Crv1 is increased.

Hereafter, portions differing from those according to the first embodiment will mainly be described. Descriptions of similar portions will be emitted.

FIG. 9 is a detailed diagram of functional blocks implementing a function related to spreading code processing in the signal processor 203.

As shown in FIG. 9, in relation to the spreading code processing, the signal processor 203 includes an orthogonal encoder 211, a codeword processor 213, a mapping unit 215, a Walsh code processor 217, and a multiplier 219.

The orthogonal encoder 211 (bi-orthogonal encoding)-performs orthogonal encoding on a symbol of an inputted DRC value. The codeword processor 213 (codeword repetition) adds a codeword to the symbol outputted from the orthogonal encoder 211. In other words, according to the embodiment, error tolerance improvement information is added to the DRC value. The error tolerance improvement information improves tolerance against transmission errors.

The mapping unit 215 assigns the symbol outputted from the codeword processor 213 to a base band signal (+1, −1).

The Walsh code processor 217 generates the Walsh codes multiplied by the multiplier 219 and outputs the generated Walsh codes. According to the embodiment, the Walsh code processor 217 configures a code number increasing unit that increases the number of spreading codes (Walsh codes).

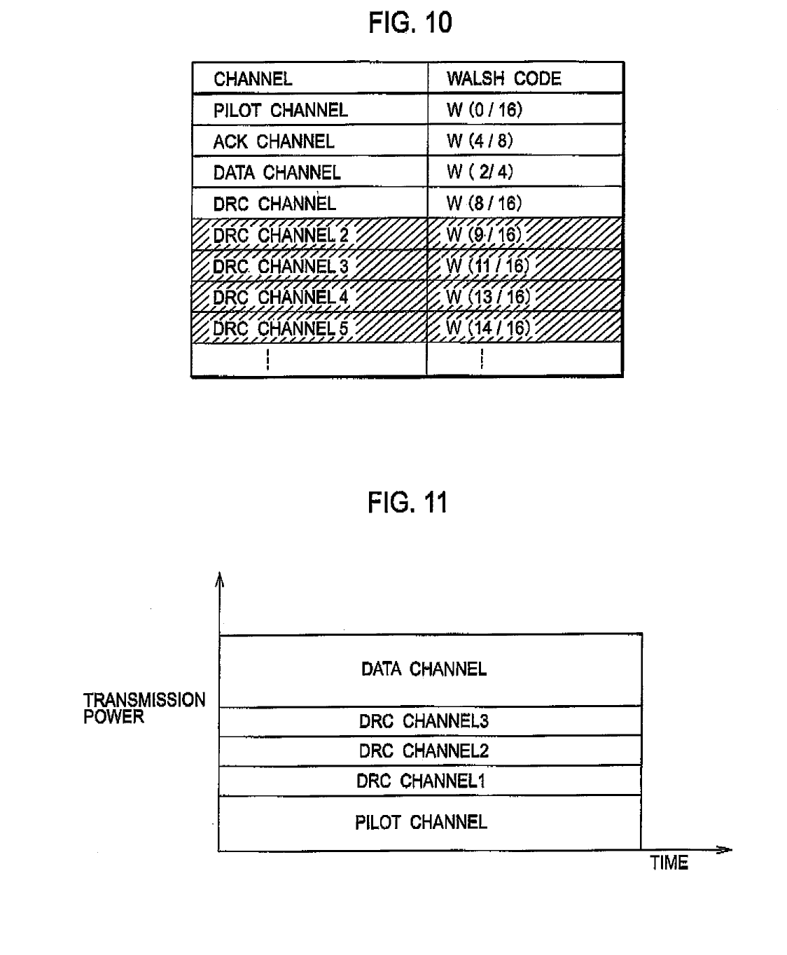

FIG. 10 is a combination of Walsh codes used according to the embodiment. In FIG. 10, a shaded portion indicates a portion added to a conventional (n×EV-DO) Walsh code.

The multiplier 219 performs code division multiplexing on the base band signal outputted from the mapping unit 215 by use of the Walsh code. In other words, in the carrier Crv1, a different spreading code is used for each channel, allowing code division multiple access. The above similarly applies to the carriers Cfw1 to Cfw3 transmitted by the radio base stations 100A to 100C.

The DRC processor 210 according to the embodiment transmits the plurality of DRC values using a new channel generated on the basis of the Walsh codes increased by the Walsh code processor 217.

Specifically, as shown in FIG. 11, a reverse link channel configuration is used in which DRC Channel 1 to DRC Channel 3 are generated by code division multiplexing. The DRC Channel 1 to DRC Channel 3 correspond to the radio base stations 100A to 100C.

### Modified Example

According to the embodiment, multiple DRC values are transmitted by a single carrier through increase of the spreading code (Walsh code). However, instead of increasing the spreading code, the multiple DRC values may be transmitted by a single carrier through omission of the addition of the error tolerance improvement information.

Specifically, the processings performed by the orthogonal encoder 211 (bi-orthogonal encoding) and the codeword processor 213 (codeword repetition unit) shown in FIG. 9 are omitted. Instead of the omitted error tolerance improvement information, the signal processor 203 transmits the plurality of DRC values by a single carrier.

As a result of the processes being omitted, 12 bits of information can be transmitted. Therefore, multiple DRC values (a DRC value is configured by four bits) can be transmitted. The information volume of the information may be further increased by a modulation (such as QPSK) of the information.

### EFFECTS AND ADVANTAGES

According to the first and second embodiments described above, when the number (one) of reverse link carriers (carrier Crv1) is less than the number (three stations) of radio base stations 100A to 100C (forward link radio base stations) transmitting the carriers Cfw1 to Cfw3 (forward link carriers), the DRC values for the radio base stations 100A to 100C are transmitted using the carrier Crv1.

The DRC values for the radio base stations 100A to 100C transmitted to the radio base station 100A are relayed to the radio base station 1003 and the radio base station 100C by an existing communication protocol.

Therefore, even in a state in which the number of reverse link carriers is less than the number of radio base stations transmitting the carriers Cfw1 to Cfw3, the radio base stations can be notified of the DRC values with certainty.

In order to transmit multiple DRC values using a single reverse link carrier, any of the following methods is used: (1) extension of DRC Length, (2) increase of spreading codes (Walsh codes), and (3) omission of error tolerance improvement information (bi-orthogonal encoding and codeword repetition).

As a result or such methods, the present invention can be easily applied without significantly changing specifications of an existing mobile communication network (n×EV-DO)

### Other Embodiments

As described above, although contents of the present invention are disclosed through an embodiment of the present invention, any description or drawing constituting a part of this disclosure should not be understood as limiting the present invention. Various alternative embodiments will be apparent from this disclosure to those skilled in the art.

For example, according to the above-described embodiments, the radio communication terminal 200 is described as a mobile phone terminal. However, the radio communication terminal 200 can be a card-type terminal that can be mounted on a personal computer, a FDA, and the like. A function of the radio communication terminal 200 of the present invention can also be provided as a module for radio communication.

According to the above-described embodiments, the radio communication terminal 200 transmits the DRC values for the radio base stations 100A to 1000 using a single reverse link carrier (carrier Crv1). However, when the radio communication terminal 200 uses two or more reverse link carriers, the radio communication terminal 200 can transmit multiple DRC values using the two or more reverse link carriers.

As described, the present invention also includes various embodiments and the like not described in this description as a matter of course. Accordingly, the technical scope of the present invention is only defined by the specific subject matters of the invention according to the scope of the invention as defined by the appended claims appropriate for this disclosure.

Note that the entire contents of Japanese Patent Application No. 2005-370173 (filed on Dec. 22, 2005) are incorporated in this description herein by reference.

### INDUSTRIAL APPLICABILITY

As described above, even when the number of reverse link carriers is less than the number of radio base stations transmitting the forward link carriers, the radio base stations can be notified of speed control values with certainty by the radio communication terminal and the communication method according to the present invention. Therefore, the radio communication terminal and the communication method according to the present invention are advantageous for radio communication, such as mobile communication.

1. A radio communication terminal configured to communicate with a plurality of radio base stations by a multicarrier using a plurality of carriers, comprising:
an expected communication speed determination unit configured to determine expected communication speed to be used on a forward link on the basis of receiving condition of the carriers; and
a speed control value transmitter configured to transmit a speed control value indicating the expected communication speed determined by the expected communication speed determination unit, to the radio base stations, wherein
when the number of reverse link carriers used for communication on a reverse link is less than the number of forward link radio base stations transmitting a forward link carrier used for communication on the forward link, the speed control value transmitter transmits the speed control value for the respective forward link radio base stations by use of any of the reverse link carriers.

2. The radio communication terminal according to claim 1, further comprising a time frame extension unit configured to extend a time frame used to transmit the speed control value, wherein
the speed control value transmitter transmits the speed control value for the forward link radio base stations by use of the time frame extended by the time frame extension unit.

3. The radio communication terminal according to claim 1, further comprising a receiver configured to receive timing of transmission of the speed control value for the radio base stations, from the radio base stations, wherein
the speed control value transmitter transmits the speed control value for the radio base stations on the basis of the timing received by the receiver.

4. The radio communication terminal, according to claim 1, wherein different spreading codes are used for respective channels, in the reverse link carriers,
the radio communication terminal further comprising a code number increasing unit configured to increase the number of the spreading codes, wherein
the speed control value transmitter transmits the speed control value for the forward link radio base stations using a new channel generated on the basis of the spreading codes increased by the code number increasing unit.

5. The radio communication terminal according to claim 1, wherein error tolerance improvement information improving tolerance against a transmission error is added to the speed control value, and
the speed control value transmitter omits addition of the error tolerance improvement information, and transmits the speed control value for the forward link radio base stations instead of the error tolerance improvement information.

6. A communication method for performing communication between a plurality of radio base stations and a radio communication terminal by a multicarrier using a plurality of carriers, comprising the steps of:
determining expected communication speed to be used on a forward link on the basis of receiving condition of the respective carriers; and
transmitting a speed control value indicating the determined expected communication speed to the respective radio base stations, wherein
when the number of reverse link carriers used for communication on a reverse link is less than the number of forward link radio base stations transmitting a forward link carrier used for communication on the forward link, the speed control value for the forward link radio base stations is transmitted using any of the reverse link carriers, in the step of transmitting.

7. The communication method according to claim 6, further comprising a step of extending a time frame used to transmit the speed control value, wherein
in the step of transmitting, the speed control value for the forward link radio base stations is transmitted using the extended time frame.

8. The communication method according to claim 6, further comprising a step of receiving timing of transmission of the speed control value for the radio base stations, from the radio base stations, wherein
in the step of transmitting, the speed control value for the radio base stations is transmitted on the basis of the timing received in the step of receiving.

9. The communication method according to claim 6, wherein
different spreading codes are used for respective channels, in the reverse link carriers,
the communication method further comprising a step of increasing the number of the spreading codes, wherein
in the step of transmitting, the speed control value for the forward link radio base stations is transmitted using a new channel generated on the basis of the increased spreading codes.

10. The communication method according to claim 6, wherein
error tolerance improvement information improving tolerance against a transmission error is added to the speed control value; and
in the step of transmitting, addition of the error tolerance improvement information is omitted, and the speed control value for the forward link radio base stations is transmitted instead of the error tolerance improvement information.
